(19) United States
(12) Patent Application Publication
(10) Pub. No.: US 2026/0271080 A1
(43) Pub. Date: Sep. 10, 2026

(54) INCLUDING PCELL IDENTITY IN RA REPORT WHILE PERFORMING RA PROCEDURE TORWARD SCG CELL

(71) Applicant: TELEFONAKTIEBOLAGET LM ERICSSON (PUBL), Stockholm (SE)

(72) Inventors: Tahmineh Torabian Esfahani, Stockholm (SE); Ali Parichehrehteroujeni, Linköping (SE)

(21) Appl. No.: 19/117,676

(22) PCT Filed: Nov. 6, 2023
(86) PCT No.: PCT/EP2023/080816

§ 371 Date: Apr. 2, 2025

Related U.S. Application Data
(60) Provisional application No. 63/423,483, filed on Nov. 7, 2022.

(51) Int. Cl. H04W 74/0833; H04W 36/00

(52) U.S. Cl. CPC H04W 74/0833; H04W 36/0069

(57) ABSTRACT

Systems and methods are disclosed that relate to Random Access (RA) reporting when performing a RA procedure toward a cell associated to a Secondary Cell Group (SCG) of the User Equipment (UE). In one embodiment, a method performed by a UE which is served by a Primary Cell (PCell) comprises performing a random access procedure toward a cell associated to a SCG of the UE and logging information for a RA report associated to the random access procedure, wherein a global cell identity of a Primary Secondary Cell (PSCell) is not available at the UE and the information logged for the RA report comprises a Global Cell Identity (CGI) of the PCell of the UE, as a result of the global cell identity of the PSCell not being available at the UE. The method further comprises sending the RA report comprising the logged information to a network node.

### RELATED APPLICATIONS

This application claims the benefit of provisional patent application Ser. No. 63/423,483, filed Nov. 7, 2022, the disclosure of which is hereby incorporated herein by reference in its entirety.

### TECHNICAL FIELD

The present disclosure relates to a cellular communications system and, more specifically, to logging and reporting of random access information.

### BACKGROUND

### Logging and Reporting of RACH Information in LTE

In 3^{rd} Generation Partnership Project (3GPP) Long Term Evolution (LTE), the report of Random Access Channel (RACH) information when a random access procedure is performed may be requested by the network via the User Equipment (UE) information procedure in the Radio Resource Control (RRC) specification (see, 3GPP Technical Specification (TS) 36.331 V17.2.0, section 5.6.5), in the case where a RACH procedure was successful.

For each RACH procedure, the UE stores the number of preambles sent, which corresponds to the parameter PREAMBLE_TRANSMISSION_COUNTER in Medium Access Control (MAC) specifications (see, e.g., 3GPP TS 36.321 V17.2.0). In the random access procedure in LTE, the UE sends a preamble and waits for a random-access response (RAR) during a pre-configured time window, which is referred to as a RAR window. If the RAR does not come within that time, the UE adjusts some preamble transmission parameters (e.g., transmission power) and transmits it again in what is called power ramping adjustment. If the procedure is successful at the n-th transmission, the preamble will be responded. The number n is what would be provided in the RACH report, so the network knows how many times the UE needed to ramp the power before the procedure was successful.

### RACH Configuration in NR

As in LTE, the random access procedure for New Radio (NR) is described in the NR MAC specifications and parameters are configured by RRC, e.g. in system information or handover (RRCReconfiguration with reconfigurationWithSync). Random access is triggered in many different scenarios, for example, when the UE is in RRC_IDLE or RRC_INACTIVE and wants to access a cell that it is camping on (i.e., transition to RRC_CONNECTED).

In NR, RACH configuration is broadcasted in System Information Block (SIB) 1 (SIB1), as part of the servingCellConfigCommon (with both DL and UL configurations), where the RACH configuration is within the uplinkConfigCommon. The exact RACH parameters are within what is called initialUplinkBWP, since this is the part of the UL frequency the UE shall access and search for RACH resources.

The RACH configuration information element focusing primarily on parameters related to the preamble power ramping functionality, i.e., power ramping step and initial power ramping, as shown for LTE in the previous section.

### NR Random Access Procedure (Preamble Power Ramping)

In LTE, the RACH report to assist the network to perform RACH optimization contains the number of preamble transmissions until the procedure succeeds. It is also very clear what has happened at the UE between the first transmission and the last transmission until the procedure was considered successful: the UE applied power ramping with a configured step and transmitted the preamble once more.

As in LTE, a similar counter PREAMBLE_TRANSMISSION_COUNTER that assists the UE to perform power ramping, sort of RACH state variable, also exists in NR.

### RACH Optimization in NR

### *****START EXCERPT FROM 3GPP TS 38.331 V17.2.0*****

### 5.7.10 UE Information

### 5.7.10.1 General

### [Reproduced Herein as FIG. 1]

### FIG. 5.7.10.1-1: UE Information Procedure

The UE information procedure is used by the network to request the UE to report information.

### 5.7.10.2 Initiation

The network initiates the procedure by sending the UEInformationRequest message. The network should initiate this procedure only after successful security activation.

### 5.7.10.3 Reception of the UEInformationRequest Message

Upon receiving the UEInformationRequest message, the UE shall, only after successful security activation:
[ . . . ]
1> if ra-ReportReq is set to true and the UE has random access related information available in VarRA-Report and if the RPLMN is included in plmn-IdentityList stored in VarRA-Report:
2> set the ra-ReportList in the UEInformationResponse message to the value of ra-ReportList in VarRA-Report,
2> discard the ra-ReportList from VarRA-Report upon successful delivery of the UEInformationResponse message confirmed by lower layers;
[ . . . ]

### 5.7.10.4 Actions Upon Successful Completion of a Random-Access Procedure or on Completion of a Request of On-Demand System Information

Upon successfully performing random-access procedure initialized with 4-step or 2-step RA type, or upon failed or successfully completed on-demand system information acquisition procedure in RRC_IDLE or RRC_INACTIVE state, the UE shall:
[ . . . ]
1> if the number of RA-Report entries stored in the ra-ReportList in VarRA-Report is less than maxRAReport:
2> if the number of PLMN entries in plmn-IdentityList stored in VarRA-Report is less than maxPLMN; or
2> if the number of PLMN entries in plmn-IdentityList stored in VarRA-Report is equal to maxPLMN and the list of EPLMNs is subset of or equal to the plmn-IdentityList stored in VarRA-Report:
   3> append the following contents associated to the successfully completed random-access procedure or the failed or successfully completed on-demand system information acquisition procedure as a new entry in the VarRA-Report:
      [ . . . ]
      4> if the corresponding random-access procedure was performed on an SCell of SCG:
      5> set the spCellId to the global cell identity of the PSCell;
[ . . . ]

### UEInformationResponse

The UEInformationResponse message is used by the UE to transfer information requested by the network.
Signalling radio bearer: SRB1 or SRB2 (when logged measurement information is included)
RLC-SAP: AM
Logical channel: DCCH
Direction: UE to network

### UEInformationResponse Message

- - ASN1START
- - TAG-UEINFORMATIONRESPONSE-START
[ ... ]

| | |
|---|---|
| RA-Report-r16 : : = | SEQUENCE { |
| cellId-r16 | CHOICE { |
| cellGlobalId-r16 | CGI-Info-Logging-r16, |
| pci-arfcn-r16 | PCI-ARFCN-NR-r16 |
| }, | |
| ra-InformationCommon-r16 | RA-InformationCommon-r16 |
| | OPTIONAL, |
| raPurpose-r16 | ENUMERATED |

{accessRelated, beamFailureRecovery, reconfigurationWithSync,
ulUnSynchronized, schedulingRequestFailure,
noPUCCHResourceAvailable, request ForOtherSI,
msg3RequestForOtherSI-r17, spare8, spare7, spare6, spare5,
spare4, spare3, spare2, spare1},

| | |
|---|---|
| . . . , | |
| [ [ | |
| spCellID-r17 | CGI-Info-Logging-r16 OTIONAL |
| ] ] | |

}
[ ... ]
- - TAG-UEINFORMATIONRESPONSE-STOP
- - ASN1STOP

*****End Excerpt from 3Gpp Ts 38.331 V17.2.0*****

### Summary

Systems and methods are disclosed that relate to Random Access (RA) reporting when performing a RA procedure toward a cell associated to a Secondary Cell Group (SCG) of the User Equipment (UE). In one embodiment, a method performed by a UE which is served by a Primary Cell (PCell) comprises performing a random access procedure toward a cell associated to a SCG of the UE and logging information for a RA report associated to the random access procedure, wherein a global cell identity of a Primary Secondary Cell (PSCell) is not available at the UE and the information logged for the RA report comprises a Global Cell Identity (CGI) of the PCell of the UE, as a result of the global cell identity of the PSCell not being available at the UE. The method further comprises sending the RA report comprising the logged information to a network node. In this manner, when the UE logs a performed RA procedure toward a Secondary Cell (SCell) in the SCG, if the CGI of the PSCell is not available at the UE, the UE logs the CGI of the PCell of the UE. As a result, the network node receiving the RA report (e.g., network node owning the PCell) would be able to forward the RA report to the network node owning the PSCell or an SCell belonging to the SCG (e.g., the one toward which the RA procedure was actually performed).

In one embodiment, logging the information comprising the CGI of the PCell of the UE for the RA report comprises logging the information comprising the CGI of the Pcell of the UE for the RA report after or during performing the random access procedure in dual connectivity operation.

In one embodiment, the UE logs the CGI of the PCell only if a global cell identity of the PSCell is not available at the UE.

In one embodiment, the cell associated to the SCG of the UE is a SCell of the SCG.

In one embodiment, the cell associated to the SCG of the UE is the PSCell.

In one embodiment, the logged information for the RA report further comprises a Tracking Area Code (TAC) of the PCell of the UE.

In one embodiment, the logged information for the RA report further comprises one or more of the following:
a Physical Cell Identity (PCI) of the cell associated to the SCG toward which the UE performed the random access procedure;
an Absolute Radio Frequency Channel Number (ARFCN) of the cell associated to the SCG toward which the UE performed the random access procedure;
an indication on whether the random access procedure is performed on an SCell belonging to SCG associated to the cell toward which the UE performed the RA procedure.

In one embodiment, the cell associated to the SCG of the UE is a cell of a New Radio (NR) or Long Term Evolution (LTE) network.

Corresponding embodiments of a UE are also disclosed. In one embodiment, a UE is adapted to perform a random access procedure toward a cell associated to a SCG of the UE and log information for a RA report associated to the random access procedure, wherein a global cell identity of a PSCell is not available at the UE and the information logged for the RA report comprises a CGI of the PCell of the UE, as a result of the global cell identity of the PSCell not being available at the UE. The UE is further adapted to send the RA report comprising the logged information to a network node.

In one embodiment, the UE is further adapted to log the information comprising the CGI of the PCell of the UE for the RA report after or during performing the random access procedure in dual connectivity operation.

In one embodiment, the UE logs the CGI of the PCell for the RA report only if a global cell identity of the PSCell is not available at the UE.

In one embodiment, the cell associated to the SCG of the UE is a SCell of the SCG.

In one embodiment, the cell associated to the SCG of the UE is the PSCell.

Embodiments of a method performed by a network node are also disclosed. In one embodiment, a method performed by a network node acting as owner of a cell that serves a UE as a PCell comprises receiving a random access report comprising a global cell identity of the PCell and a physical cell identity of a cell associated to a SCG of the UE toward which the UE performed a random access procedure. The method further comprises, upon receiving the random access report comprising the global cell identity of the PCell and the physical cell identity of the cell associated to the SCG of the UE, determining whether the random access report should be forwarded to a Radio Access Network (RAN) node serving the cell associated to the SCG of the UE toward which the UE performed the random access procedure, determining a global cell identity of the cell toward which the UE performed the random access procedure based on a neighbor relation table, and forwarding the random access report to a RAN node that serves the cell identified by the determined global cell identity.

In one embodiment, the cell associated to the SCG of the UE toward which the UE performed the random access procedure is a SCell of the SCG.

In one embodiment, the cell associated to the SCG of the UE toward which the UE performed the random access procedure is a PSCell.

In one embodiment, determining the global cell identity of the cell toward which the UE performed the random access procedure comprises determining the global cell identity of the cell toward which the UE performed the random access procedure by mapping the physical cell identity and frequency information of the cell to a global cell identity of the cell toward which the random access procedure was performed.

In one embodiment, the random access report further comprises a TAC of the PCell of the UE.

In one embodiment, the random access report further comprises one or more of the following:
an Absolute Radio Frequency Channel Number, ARFCN, of the cell associated to the SCG toward which the UE performed the random access procedure;
an indication on whether the random access procedure is performed on an SCell belonging to SCG associated to the cell toward which the UE performed the RA procedure.

In one embodiment, the network node is a network node for a NR or LTE network.

Corresponding embodiments of a network node are also disclosed. In one embodiment, a network node for acting as owner of a cell that served a UE as a PCell is adapted to receive a random access report comprising a global cell identity of the PCell and a physical cell identity of a cell associated to a SCG of the UE toward which the UE performed a random access procedure. The network node is further adapted to, upon receiving the random access report comprising the global cell identity of the PCell and the physical cell identity of the cell associated to the SCG of the UE, determine that the random access report should be forwarded to a RAN node serving the cell associated to the SCG of the UE toward which the UE performed the random access procedure, determine a global cell identity of the cell toward which the UE performed the random access procedure based on a neighbor relation table, and forward the random access report to a RAN node that serves the cell identified by the determined global cell identity.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 is a reproduction of FIG. 5.7.10.1-1 of 3GPP TS 38.331 V17.2.0;

FIG. 2 is a flow chart that illustrates the operation of a UE for logging and reporting random access (RA) information, in accordance with an embodiment of the present disclosure;

FIG. 3 is a flow chart that illustrates the operation of a network node, in accordance with one embodiment of the present disclosure;

FIG. 4 shows an example of a communication system in accordance with some embodiments;

FIG. 5 shows a UE in accordance with some embodiments;

FIG. 6 shows a network node in accordance with some embodiments;

FIG. 7 is a block diagram of a host, which may be an embodiment of the host of FIG. 4, in accordance with various aspects described herein;

FIG. 8 is a block diagram illustrating a virtualization environment in which functions implemented by some embodiments may be virtualized; and

FIG. 9 shows a communication diagram of a host communicating via a network node with a UE over a partially wireless connection in accordance with some embodiments.

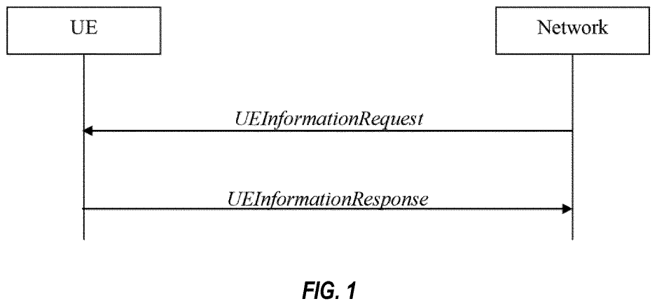

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

There currently exist certain challenge(s). In the current Random Access (RA) procedure specified in the New Radio (NR) Radio Resource Control (RRC) Technical Specification (TS) 38.331, the User Equipment (UE) logs Physical Cell Identity (PCI) and Absolute Radio Frequency Channel Number (ARFCN) value of the cells if Cell Global Identity (CGI) of the cell is not known or the UE is not reading the CGIs. For instance, in Multi-Radio Access Technology (RAT) Dual Connectivity (MR-DC) operation and also in carrier aggregation configuration, when a UE performs the Random Access Channel (RACH) procedure towards the secondary node (Secondary Cells (SCells)) of a Secondary Cell Group (SCG) in which the UE is not necessarily reading the CGIs, the UE logs the Primary SCell (PSCell) CGI as highlighted in the excerpt from 3GPP TS 38.331 below (emphasis added via bold, italicized text):

*****Start Excerpt from 3Gpp Ts 38.331*****
5.7.10.4 Actions upon successful completion of a random-access procedure or on completion of a request of on-demand system information

Upon successfully performing random-access procedure initialized with 4-step or 2-step RA type, or upon failed or successfully completed on-demand system information acquisition procedure in RRC_IDLE or RRC_INACTIVE state, the UE shall:
[ . . . ]
1> if the number of RA-Report entries stored in the ra-ReportList in VarRA-Report is less than maxRAReport:
2> if the number of PLMN entries in plmn-IdentityList stored in VarRA-Report is less than maxPLMN; or
2> if the number of PLMN entries in plmn-IdentityList stored in VarRA-Report is equal to maxPLMN and the list of EPLMNs is subset of or equal to the plmn-IdentityList stored in VarRA-Report:
   3> append the following contents associated to the successfully completed random-access procedure or the failed or successfully completed on-demand system information acquisition procedure as a new entry in the VarRA-Report:

[ ... ]
4> if the corresponding random-access procedure was performed
on an SCell of SCG:
5> set the spCellId to the global cell identity of the PSCell;
[ ... ]

*****End Excerpt from 3Gpp Ts 38.331*****

However, this could be an issue in case the UE logs the PCI and ARFCN of PSCell in the Random Access (RA) report in a MR-DC operation and also the RA report is retrieved in other places by another cell. Moreover, if the logged PSCell PCI is not known for the receiving cell, the receiving cell cannot detect to which cell(s) the RACH reports in the RA-ReportList belong. Hence, it will not be possible to forward the RA reports to the cell in which the RACH procedures are performed.

Certain aspects of the disclosure and their embodiments may provide solutions to these or other challenges.

### UE Embodiments:

Embodiments of a method performed by a wireless terminal (also called User Equipment, and referred to as a UE in the description herein) are disclosed. In one embodiment, a method performed by a wireless terminal (or UE) comprises, after or during performance of a RACH procedure in dual connectivity operation:
Upon performing a RA toward a cell associated to the SCG, the UE logs the following:
   Global Cell ID (CGI) and tracking area code (TAC) of the Primary Cell (PCell) i.e., the primary cell belonging to the Master Cell Group (MCG), and
   Optionally, one or more of the following:
      Physical Cell Identity (PCI) of the cell belonging to the SCG toward which the UE performed the RA procedure,
      ARFCN of the cell belonging to the SCG toward which the UE performed the RA procedure,
      an indication on whether the RA procedure is performed on SCell belonging to SCG PCI of the secondary cell.
In an embodiment, the cell associated to the SCG toward which the RA procedure is performed is a PSCell.
In another embodiment, the cell associated to the SCG toward which the RA procedure is performed is a SCell belonging to the set of SCG cells.
In one general embodiment, the UE logs the global cell identity information of the PCell in the RA report logged in response to performing a RA procedure toward a cell belonging to the SCG, when the PSCell identity is not available at the UE at the time of logging the RA report.
   The global cell identity of the PSCell might be available at the UE only if the UE reads the Systems Information Block (SIB) 1 (SIB1) of the PSCell or the UE receives the global cell identity of the PSCell via a dedicated Radio Resource Control (RRC) signaling. In another case, the global cell identity of the PSCell is not available, and UE shall log the global cell identity of the PCell when performing a random access procedure toward any cell belonging to the SCG.

### Network Side Embodiments

Embodiments of a method performed by a network node (e.g., a Radio Access Network (RAN) node such as, e.g., a base station (e.g., an evolved Node B (eNB), gNodeB (gNB), or the like) are also disclosed herein. In one embodiment, a method performed by a network node (e.g., a RAN node such as, e.g., a base station (e.g., an eNB, gNB, or the like) acting as owner of a cell that served a UE as a PCell, comprises one or more of the following steps upon receiving an RA report including a global cell identity of the PCell and a physical cell identity of a cell belonging to a SCG of the UE (e.g., a PSCell or an SCell belonging to the SCG):
Step 1: The network node (the node owning/serving the PCell for the UE) determines whether the report should be forwarded to the RAN node owning/serving the PSCell or SCell for the UE.
   The determination can be done based on the global cell ID of the PCell and the physical cell ID and frequency information of the PSCell/SCell that is not part of the MCG cells.
Step 2: Upon such determination (in Step 1), determining the global cell ID of the cell toward which the RA procedure was performed based on the neighbor relation table e.g., by mapping the PCI and frequency information (ARFCN) to the CGI of the neighboring cell.
Step 3: Forwarding the RA report to the determined neighboring RAN node that owns/serves the cell determined in Step 2 (i.e., the cell toward which the RA procedure was performed and the RA report was generated in response to performing the RA procedure).

In one embodiment, systems and methods are disclosed herein that enable a network node to fetch RA information of secondary cells associated to a SCG in MR-DC operation related to network configuration. In particular, the RAN nodes would be capable to find and forward the associated RA report in MR-DC operation for RACH performance optimization.

While not being limited to or by any particular advantage, embodiments of the present disclosure may provide a number of advantages over existing technology. For example, having an embodiment in place, the SCells of SCG in carrier aggregation scenarios would be able to receive the RA report and optimize/tune the RACH parameters.

The advantage of the proposed solution is when a UE logs a performed RA procedure toward the SCell, if the CGI of the PSCell is not available at the UE, the UE logs the CGI of the PCell belonging to the MCG; hence the RACH report can be forwarded to the closest RAN node (the Master Node (MN)) to the RAN node (Secondary Node (SN)) serving the cells as SCG for the UE. Hence, the RAN node receiving the RACH report (e.g., RAN node owning the PCell i.e., MN) would be able to forward the RA report to the RAN node owning the PSCell or an SCell belonging to the SCG (the one toward which the RA procedure was actually performed).

Some of the embodiments contemplated herein will now be described more fully with reference to the accompanying drawings. Embodiments are provided by way of example to convey the scope of the subject matter to those skilled in the art.

Note that embodiments of the present disclosure are applicable to Long Term Evolution (LTE), NR, and possibly future generations of a 3GPP system. Also note that the terms “network node” and “RAN node” are used interchangeably in the description provided herein.

### UE Embodiments

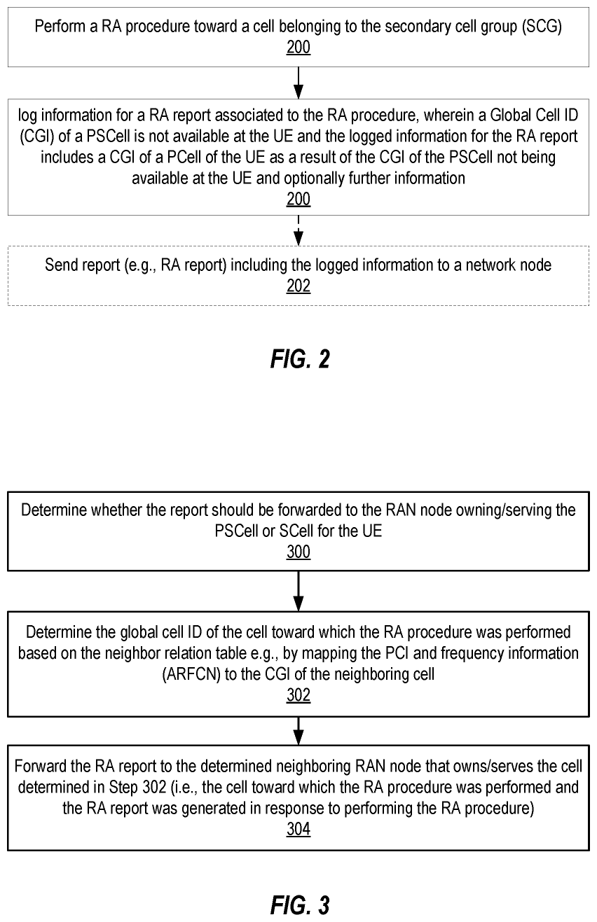

Embodiments of a method performed by a wireless terminal (also called User Equipment, and referred as a UE in the description herein) are disclosed. As illustrated in FIG. 2, in one embodiment, a method performed by a wireless terminal (or UE) comprises, after or during performance of a RACH procedure in dual connectivity operation (e.g., a MR-DC operation such as, e.g., a NR Dual Connectivity (NR-DC) operation, Evolved Universal Terrestrial Radio Access (E-UTRA)-NR Dual Connectivity (EN-DC) operation, or NR-E-UTRA Dual Connectivity (NE-DC) operation):
Step 200: The UE performs a RA procedure toward a cell belonging to (i.e., associated to) the secondary cell group (SCG).
Step 202: The UE logs information for a RA report (e.g., in one or more variables for the RA report) associated to the RA procedure performed in step 200. In the embodiment illustrated in FIG. 2, a CGI of a PSCell is not available at the UE, and the information logged for the RA report comprises a CGI of the PCell of the UE (e.g., the CGI of the PCell of the UE is stored in a variable for the RA report), as a result of the CGI of the PSCell not being available at the UE.
Upon performing the RA procedure toward the cell belonging to the SCG in step 200, the UE logs (e.g., in a RA report):
   A Global Cell ID (CGI) and tracking area code (TAC) of a PCell of the UE
      The UE is already required to read the CGI and TAC of the PCell and, upon performing RACH toward a cell belonging to the SCG cells, the UE can log the PCell ID as part of RA report performed toward SCell belonging to the SCG cells.
      In one embodiment, the UE logs the CGI and TAC of the PCell only if the global cell identity of the PSCell is not available at the UE (or not known by the UE).
   Optionally, the UE may further log (e.g., in the RA report) any one or more of the following:
      The Physical cell identity (PCI) of the belonging to the SCG toward which the UE performed the RA procedure.
         In this scenario, the Global Cell ID (CGI) of the PSCell is not known by the UE.
      ARFCN of the cell belonging to the SCG toward which the UE performed the RA procedure.
         In this scenario, the Global Cell ID (CGI) of the PSCell is not known by the UE.
      An indication on whether the RACH procedure is performed on SCell belonging to SCG Physical cell identity (PCI) of the secondary cell.
Step 204: The UE sends to RA report including the logged information to a network node.

In one embodiment, the cell associated to the Secondary Cell Group (SCG) toward which the RA procedure is performed is a Primary Secondary cell (PSCell)

In another embodiment, the cell associated to the Secondary Cell Group (SCG) toward which the RA procedure is performed is a Secondary Cell (SCell) belonging to the set of SCG cells.

In a generic embodiment, the UE logs the global cell identity information of the PCell in the RA report logged in response to performing a RA procedure toward a cell belonging to the SCG, when the PSCell identity is not available at the UE at the time of logging the RA report.
The global cell identity of the PSCell might be available at the UE only if the UE reads the SIB1 of the PSCell or the UE receives the global cell identity of the PSCell via a dedicated RRC signalling. In other case the global cell identity of the PSCell is not available and UE shall log the global cell identity of the PCell when performing a random access procedure toward any cell belonging to the secondary cell group (SCG).

### Network Side Embodiments

Embodiments of a method performed by a network node (e.g., a RAN node such as, e.g., a base station (e.g., an eNB, gNB, or the like) are also disclosed herein. In one embodiment, a method performed by a network node (e.g., a RAN node such as, e.g., a base station (e.g., an eNB, gNB, or the like) acting as owner of a cell that served a UE as a PCell is as follows. As illustrated in FIG. 3, the method comprises one or more of the following steps upon receiving an RA report including a global cell identity of a PCell and a physical cell identity of a cell belonging to a SCG of a UE (e.g., a PSCell or an SCell belonging to the SCG)
Step 300: The network node (the node owning/serving the PCell for the UE) determines whether the report should be forwarded to the RAN node owning/serving the PSCell or SCell for the UE.
The determination can be done based on the global cell ID of the PCell and the physical cell ID and frequency information of the PSCell/SCell that is not part of the MCG cells
Step 302: Upon such determination (in Step 300), determining the global cell ID of the cell toward which the RA procedure was performed based on the neighbor relation table e.g., by mapping the PCI and frequency information (ARFCN) to the CGI of the neighboring cell.
Step 304: Forwarding the RA report to the determined neighboring RAN node that owns/serves the cell determined in Step 302 (i.e., the cell toward which the RA procedure was performed and the RA report was generated in response to performing the RA procedure).

### Example Implementation

The following is a non-limiting example implementation of at least one embodiment of the present disclosure in the RRC specifications:

### 5.7.10.4 Actions Upon Successful Completion of a Random-Access Procedure or on Completion of a Request of On-Demand System Information

[ . . . ]
1> if the number of RA-Report entries stored in the ra-ReportList in VarRA-Report is less than maxRAReport:
2> if the number of PLMN entries in plmn-IdentityList stored in VarRA-Report is less than maxPLMN; or
2> if the number of PLMN entries in plmn-IdentityList stored in VarRA-Report is equal to maxPLMN and the list of EPLMNs is subset of or equal to the plmn-IdentityList stored in VarRA-Report:
   3> append the following contents associated to the successfully completed random-access procedure or the failed or successfully completed on-demand system information acquisition procedure as a new entry in the VarRA-Report:

```
    [ ... ]
  4> if the corresponding random-access procedure was performed
    on an SCell of SCG:
    5> set the spCellId to the global cell identity of the PSCell,
    if available;
    5> else:
      6> set the spCellId to the global cell identity of the PCell.
[ ... ]
```

### UEInformationResponse

The UEInformationResponse message is used by the UE to transfer information requested by the network.
Signalling radio bearer: SRB1 or SRB2 (when logged measurement information is included)
RLC-SAP: AM
Logical channel: DCCH
Direction: UE to network

### UEInformation Response Message

- - ASN1START
- - TAG-UEINFORMATIONRESPONSE-START
[ ... ]

| | |
|---|---|
| RA-Report-r16 : : = | SEQUENCE { |
| cellId-r16 | CHOICE { |
| cellGlobalId-r16 | CGI-Info-Logging-r16, |
| pci-arfcn-r16 | PCI-ARFCN-NR-r16 |
| }, | |
| ra-InformationCommon-r16 | RA-InformationCommon- |

r16 OPTIONAL,

| | |
|---|---|
| raPurpose-r16 | ENUMERATED |

{accessRelated, beamFailureRecovery, reconfigurationWithSync,
ulUnSynchronized, schedulingRequestFailure,
noPUCCHResourceAvailable, request ForOtherSI,
msg3requestForOtherSI-r17, spare8, spare7, spare6, spare5,
spare4, spare3, spare2, spare1},
. . . ,

| | |
|---|---|
| spCellID-r17 | CGI-Info-Logging-r16 OPTIONAL |
| [ [ | |
| PCellId-r17 | CGI-Info-Logging-r16 OPTIONAL |
| ] ] | |
| } | |

[ ... ]
- - TAG-UEINFORMATIONRESPONSE-STOP
- - ASN1STOP

UEInformation Response-IEs field descriptions

PCellId
This field indicates the CGI of the PCell of
MCG in which the associated random
access procedure was performed towards an SCell belonging to the SCG.

### Further Network Side Embodiments

Upon receiving the list of RA reports by a RAN node if the global cell ID and TAC associated to PSCell in MR-DC operation in which the RACH is performed toward to an SCell is missing, the node receiving the RA report forwards the RA report to the PCell over if PCell ID is included in the RA report as the following:
The node receiving the RA report forwards the RA report to the PCell over Xn interface (if there is any)
   In one embodiment, the RAN node receiving the RA report forwards the RA report associated to SCell of SCG to the logged PCell over Xn interface e.g., using Access and Mobility Indication Signal
The node receiving the RA report forwards the RA report to the PCell via core network over NG interface
   In another embodiment, the RAN node receiving the RA report forwards the RA report associated to SCell of SCG to the logged PCell over NG interface via core network using CGI of the PCell and TAC that are reported by the UE as part of RA report.

### Further Description

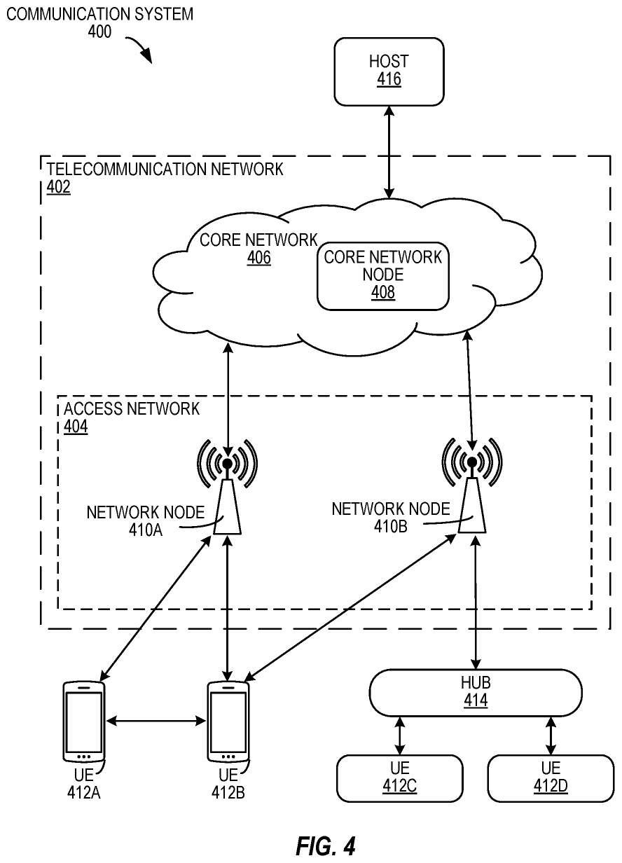

FIG. 4 shows an example of a communication system 400 in accordance with some embodiments.

In the example, the communication system 400 includes a telecommunication network 402 that includes an access network 404, such as a Radio Access Network (RAN), and a core network 406, which includes one or more core network nodes 408. The access network 404 includes one or more access network nodes, such as network nodes 410A and 410B (one or more of which may be generally referred to as network nodes 410), or any other similar Third Generation Partnership Project (3GPP) access node or non-3GPP Access Point (AP). The network nodes 410 facilitate direct or indirect connection of User Equipment (UE), such as by connecting UEs 412A, 412B, 412C, and 412D (one or more of which may be generally referred to as UEs 412) to the core network 406 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 400 may include any number of wired or wireless networks, network nodes, UEs, and/or any other components or systems that may facilitate or participate in the communication of data and/or signals whether via wired or wireless connections. The communication system 400 may include and/or interface with any type of communication, telecommunication, data, cellular, radio network, and/or other similar type of system.

The UEs 412 may be any of a wide variety of communication devices, including wireless devices arranged, configured, and/or operable to communicate wirelessly with the network nodes 410 and other communication devices. Similarly, the network nodes 410 are arranged, capable, configured, and/or operable to communicate directly or indirectly with the UEs 412 and/or with other network nodes or equipment in the telecommunication network 402 to enable and/or provide network access, such as wireless network access, and/or to perform other functions, such as administration in the telecommunication network 402.

In the depicted example, the core network 406 connects the network nodes 410 to one or more hosts, such as host 416. These connections may be direct or indirect via one or more intermediary networks or devices. In other examples, network nodes may be directly coupled to hosts. The core network 406 includes one more core network nodes (e.g., core network node 408) that are structured with hardware and software components. Features of these components may be substantially similar to those described with respect to the UEs, network nodes, and/or hosts, such that the descriptions thereof are generally applicable to the corresponding components of the core network node 408. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 416 may be under the ownership or control of a service provider other than an operator or provider of the access network 404 and/or the telecommunication network 402, and may be operated by the service provider or on behalf of the service provider. The host 416 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 400 of FIG. 4 enables connectivity between the UEs, network nodes, and hosts. In that sense, the communication system 400 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 402 is a cellular network that implements 3GPP standardized features. Accordingly, the telecommunication network 402 may support network slicing to provide different logical networks to different devices that are connected to the telecommunication network 402. For example, the telecommunication network 402 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 412 are configured to transmit and/or receive information without direct human interaction. For instance, a UE may be designed to transmit information to the access network 404 on a predetermined schedule, when triggered by an internal or external event, or in response to requests from the access network 404. Additionally, a UE may be configured for operating in single- or multi-Radio Access Technology (RAT) or multi-standard mode. For example, a UE may operate with any one or combination of WiFi, New Radio (NR), and LTE, i.e. be configured for Multi-Radio Dual Connectivity (MR-DC), such as Evolved UMTS Terrestrial RAN (E-UTRAN) NR-Dual Connectivity (EN-DC).

In the example, a hub 414 communicates with the access network 404 to facilitate indirect communication between one or more UEs (e.g., UE 412C and/or 412D) and network nodes (e.g., network node 410B). In some examples, the hub 414 may be a controller, router, content source and analytics, or any of the other communication devices described herein regarding UEs. For example, the hub 414 may be a broadband router enabling access to the core network 406 for the UEs. As another example, the hub 414 may be a controller that sends commands or instructions to one or more actuators in the UEs. Commands or instructions may be received from the UEs, network nodes 410, or by executable code, script, process, or other instructions in the hub 414. As another example, the hub 414 may be a data collector that acts as temporary storage for UE data and, in some embodiments, may perform analysis or other processing of the data. As another example, the hub 414 may be a content source. For example, for a UE that is a Virtual Reality (VR) headset, display, loudspeaker or other media delivery device, the hub 414 may retrieve VR assets, video, audio, or other media or data related to sensory information via a network node, which the hub 414 then provides to the UE either directly, after performing local processing, and/or after adding additional local content. In still another example, the hub 414 acts as a proxy server or orchestrator for the UEs, in particular in if one or more of the UEs are low energy IoT devices.

The hub 414 may have a constant/persistent or intermittent connection to the network node 410B. The hub 414 may also allow for a different communication scheme and/or schedule between the hub 414 and UEs (e.g., UE 412C and/or 412D), and between the hub 414 and the core network 406. In other examples, the hub 414 is connected to the core network 406 and/or one or more UEs via a wired connection. Moreover, the hub 414 may be configured to connect to a Machine-to-Machine (M2M) service provider over the access network 404 and/or to another UE over a direct connection. In some scenarios, UEs may establish a wireless connection with the network nodes 410 while still connected via the hub 414 via a wired or wireless connection. In some embodiments, the hub 414 may be a dedicated hub—that is, a hub whose primary function is to route communications to/from the UEs from/to the network node 410B. In other embodiments, the hub 414 may be a non-dedicated hub—that is, a device which is capable of operating to route communications between the UEs and the network node 410B, but which is additionally capable of operating as a communication start and/or end point for certain data channels.

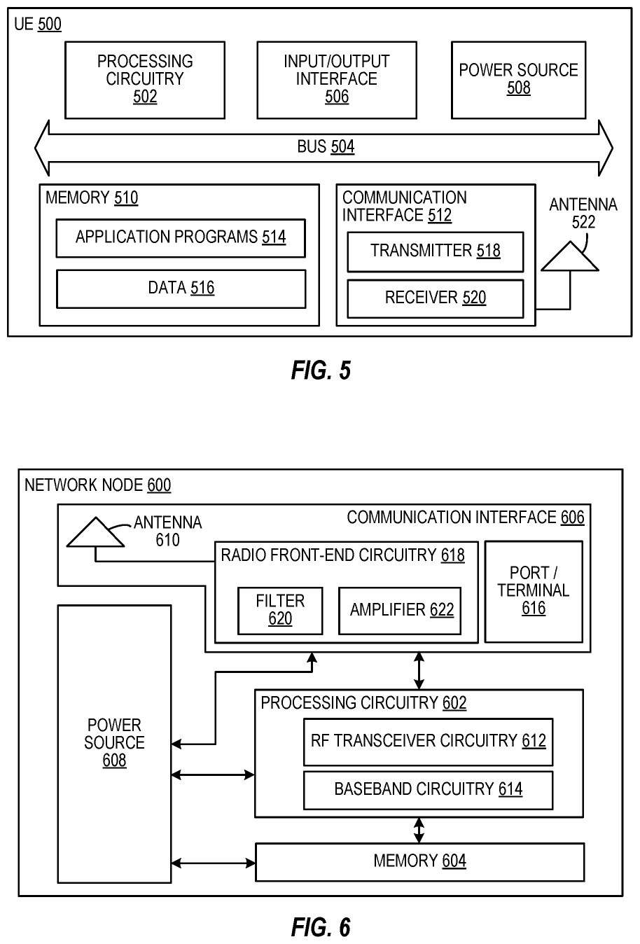

FIG. 5 shows a UE 500 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VOIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 500 includes processing circuitry 502 that is operatively coupled via a bus 504 to an input/output interface 506, a power source 508, memory 510, a communication interface 512, and/or any other component, or any combination thereof. Certain UEs may utilize all or a subset of the components shown in FIG. 5. The level of integration between the components may vary from one UE to another UE. Further, certain UEs may contain multiple instances of a component, such as multiple processors, memories, transceivers, transmitters, receivers, etc.

The processing circuitry 502 is configured to process instructions and data and may be configured to implement any sequential state machine operative to execute instructions stored as machine-readable computer programs in the memory 510. The processing circuitry 502 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 502 may include multiple Central Processing Units (CPUs).

In the example, the input/output interface 506 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 500. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 508 is structured as a battery or battery pack. Other types of power sources, such as an external power source (e.g., an electricity outlet), photovoltaic device, or power cell, may be used. The power source 508 may further include power circuitry for delivering power from the power source 508 itself, and/or an external power source, to the various parts of the UE 500 via input circuitry or an interface such as an electrical power cable. Delivering power may be, for example, for charging the power source 508. Power circuitry may perform any formatting, converting, or other modification to the power from the power source 508 to make the power suitable for the respective components of the UE 500 to which power is supplied.

The memory 510 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 510 includes one or more application programs 514, such as an operating system, web browser application, a widget, gadget engine, or other application, and corresponding data 516. The memory 510 may store, for use by the UE 500, any of a variety of various operating systems or combinations of operating systems.

The memory 510 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 510 may allow the UE 500 to access instructions, application programs, and the like stored on transitory or non-transitory memory media, to off-load data, or to upload data. An article of manufacture, such as one utilizing a communication system, may be tangibly embodied as or in the memory 510, which may be or comprise a device-readable storage medium.

The processing circuitry 502 may be configured to communicate with an access network or other network using the communication interface 512. The communication interface 512 may comprise one or more communication subsystems and may include or be communicatively coupled to an antenna 522. The communication interface 512 may include one or more transceivers used to communicate, such as by communicating with one or more remote transceivers of another device capable of wireless communication (e.g., another UE or a network node in an access network). Each transceiver may include a transmitter 518 and/or a receiver 520 appropriate to provide network communications (e.g., optical, electrical, frequency allocations, and so forth). Moreover, the transmitter 518 and receiver 520 may be coupled to one or more antennas (e.g., the antenna 522) and may share circuit components, software, or firmware, or alternatively be implemented separately.

In the illustrated embodiment, communication functions of the communication interface 512 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 512, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 500 shown in FIG. 5.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 6 shows a network node 600 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 600 includes processing circuitry 602, memory 604, a communication interface 606, and a power source 608. The network node 600 may be composed of multiple physically separate components (e.g., a Node B component and an RNC component, or a BTS component and a BSC component, etc.), which may each have their own respective components. In certain scenarios in which the network node 600 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 600 may be configured to support multiple RATs. In such embodiments, some components may be duplicated (e.g., separate memory 604 for different RATs) and some components may be reused (e.g., an antenna 610 may be shared by different RATs). The network node 600 may also include multiple sets of the various illustrated components for different wireless technologies integrated into network node 600, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 600.

The processing circuitry 602 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 600 components, such as the memory 604, to provide network node 600 functionality.

In some embodiments, the processing circuitry 602 includes a System on a Chip (SOC). In some embodiments, the processing circuitry 602 includes one or more of Radio Frequency (RF) transceiver circuitry 612 and baseband processing circuitry 614. In some embodiments, the RF transceiver circuitry 612 and the baseband processing circuitry 614 may be on separate chips (or sets of chips), boards, or units, such as radio units and digital units. In alternative embodiments, part or all of the RF transceiver circuitry 612 and the baseband processing circuitry 614 may be on the same chip or set of chips, boards, or units.

The memory 604 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 602. The memory 604 may store any suitable instructions, data, or information, including a computer program, software, an application including one or more of logic, rules, code, tables, and/or other instructions capable of being executed by the processing circuitry 602 and utilized by the network node 600. The memory 604 may be used to store any calculations made by the processing circuitry 602 and/or any data received via the communication interface 606. In some embodiments, the processing circuitry 602 and the memory 604 are integrated.

The communication interface 606 is used in wired or wireless communication of signaling and/or data between a network node, access network, and/or UE. As illustrated, the communication interface 606 comprises port(s)/terminal(s) 616 to send and receive data, for example to and from a network over a wired connection. The communication interface 606 also includes radio front-end circuitry 618 that may be coupled to, or in certain embodiments a part of, the antenna 610. The radio front-end circuitry 618 comprises filters 620 and amplifiers 622. The radio front-end circuitry 618 may be connected to the antenna 610 and the processing circuitry 602. The radio front-end circuitry 618 may be configured to condition signals communicated between the antenna 610 and the processing circuitry 602. The radio front-end circuitry 618 may receive digital data that is to be sent out to other network nodes or UEs via a wireless connection. The radio front-end circuitry 618 may convert the digital data into a radio signal having the appropriate channel and bandwidth parameters using a combination of the filters 620 and/or the amplifiers 622. The radio signal may then be transmitted via the antenna 610. Similarly, when receiving data, the antenna 610 may collect radio signals which are then converted into digital data by the radio front-end circuitry 618. The digital data may be passed to the processing circuitry 602. In other embodiments, the communication interface 606 may comprise different components and/or different combinations of components.

In certain alternative embodiments, the network node 600 does not include separate radio front-end circuitry 618; instead, the processing circuitry 602 includes radio front-end circuitry and is connected to the antenna 610. Similarly, in some embodiments, all or some of the RF transceiver circuitry 612 is part of the communication interface 606. In still other embodiments, the communication interface 606 includes the one or more ports or terminals 616, the radio front-end circuitry 618, and the RF transceiver circuitry 612 as part of a radio unit (not shown), and the communication interface 606 communicates with the baseband processing circuitry 614, which is part of a digital unit (not shown).

The antenna 610 may include one or more antennas, or antenna arrays, configured to send and/or receive wireless signals. The antenna 610 may be coupled to the radio front-end circuitry 618 and may be any type of antenna capable of transmitting and receiving data and/or signals wirelessly. In certain embodiments, the antenna 610 is separate from the network node 600 and connectable to the network node 600 through an interface or port.

The antenna 610, the communication interface 606, and/or the processing circuitry 602 may be configured to perform any receiving operations and/or certain obtaining operations described herein as being performed by the network node 600. Any information, data, and/or signals may be received from a UE, another network node, and/or any other network equipment. Similarly, the antenna 610, the communication interface 606, and/or the processing circuitry 602 may be configured to perform any transmitting operations described herein as being performed by the network node 600. Any information, data, and/or signals may be transmitted to a UE, another network node, and/or any other network equipment.

The power source 608 provides power to the various components of the network node 600 in a form suitable for the respective components (e.g., at a voltage and current level needed for each respective component). The power source 608 may further comprise, or be coupled to, power management circuitry to supply the components of the network node 600 with power for performing the functionality described herein. For example, the network node 600 may be connectable to an external power source (e.g., the power grid or an electricity outlet) via input circuitry or an interface such as an electrical cable, whereby the external power source supplies power to power circuitry of the power source 608. As a further example, the power source 608 may comprise a source of power in the form of a battery or battery pack which is connected to, or integrated in, power circuitry. The battery may provide backup power should the external power source fail.

Embodiments of the network node 600 may include additional components beyond those shown in FIG. 6 for providing certain aspects of the network node's functionality, including any of the functionality described herein and/or any functionality necessary to support the subject matter described herein. For example, the network node 600 may include user interface equipment to allow input of information into the network node 600 and to allow output of information from the network node 600. This may allow a user to perform diagnostic, maintenance, repair, and other administrative functions for the network node 600.

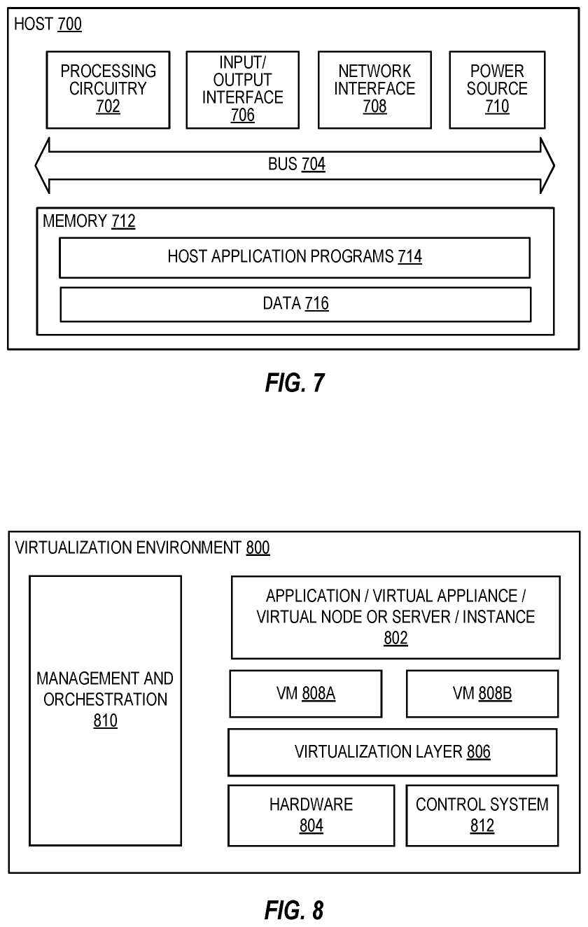

FIG. 7 is a block diagram of a host 700, which may be an embodiment of the host 416 of FIG. 4, in accordance with various aspects described herein. As used herein, the host 700 may be or comprise various combinations of hardware and/or software including a standalone server, a blade server, a cloud-implemented server, a distributed server, a virtual machine, container, or processing resources in a server farm. The host 700 may provide one or more services to one or more UEs.

The host 700 includes processing circuitry 702 that is operatively coupled via a bus 704 to an input/output interface 706, a network interface 708, a power source 710, and memory 712. Other components may be included in other embodiments. Features of these components may be substantially similar to those described with respect to the devices of previous figures, such as FIGS. 5 and 6, such that the descriptions thereof are generally applicable to the corresponding components of the host 700.

The memory 712 may include one or more computer programs including one or more host application programs 714 and data 716, which may include user data, e.g. data generated by a UE for the host 700 or data generated by the host 700 for a UE. Embodiments of the host 700 may utilize only a subset or all of the components shown. The host application programs 714 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 714 may also provide for user authentication and licensing checks and may periodically report health, routes, and content availability to a central node, such as a device in or on the edge of a core network. Accordingly, the host 700 may select and/or indicate a different host for Over-The-Top (OTT) services for a UE. The host application programs 714 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 8 is a block diagram illustrating a virtualization environment 800 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 800 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 802 (which may alternatively be called software instances, virtual appliances, network functions, virtual nodes, virtual network functions, etc.) are run in the virtualization environment 700 to implement some of the features, functions, and/or benefits of some of the embodiments disclosed herein.

Hardware 804 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 806 (also referred to as hypervisors or VM Monitors (VMMs)), provide VMs 808A and 808B (one or more of which may be generally referred to as VMs 808), and/or perform any of the functions, features, and/or benefits described in relation with some embodiments described herein. The virtualization layer 806 may present a virtual operating platform that appears like networking hardware to the VMs 808.

The VMs 808 comprise virtual processing, virtual memory, virtual networking, or interface and virtual storage, and may be run by a corresponding virtualization layer 806. Different embodiments of the instance of a virtual appliance 802 may be implemented on one or more of the VMs 808, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 808 may be a software implementation of a physical machine that runs programs as if they were executing on a physical, non-virtualized machine. Each of the VMs 808, and that part of the hardware 804 that executes that VM, be it hardware dedicated to that VM and/or hardware shared by that VM with others of the VMs 808, forms separate virtual network elements. Still in the context of NFV, a virtual network function is responsible for handling specific network functions that run in one or more VMs 808 on top of the hardware 804 and corresponds to the application 802.

The hardware 804 may be implemented in a standalone network node with generic or specific components. The hardware 804 may implement some functions via virtualization. Alternatively, the hardware 804 may be part of a larger cluster of hardware (e.g., such as in a data center or CPE) where many hardware nodes work together and are managed via management and orchestration 810, which, among others, oversees lifecycle management of the applications 802. In some embodiments, the hardware 804 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 812 which may alternatively be used for communication between hardware nodes and radio units.

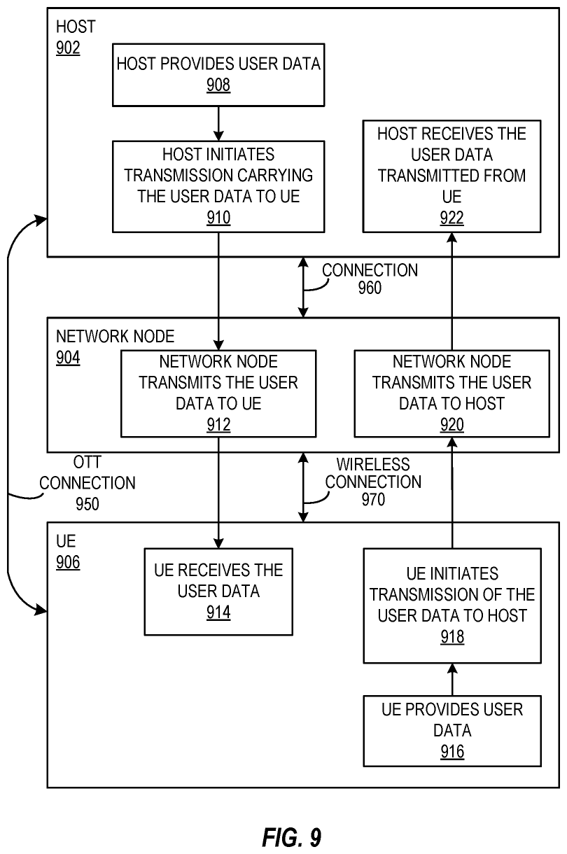

FIG. 9 shows a communication diagram of a host 902 communicating via a network node 904 with a UE 906 over a partially wireless connection in accordance with some embodiments. Example implementations, in accordance with various embodiments, of the UE (such as the UE 412A of FIG. 4 and/or the UE 500 of FIG. 5), the network node (such as the network node 410A of FIG. 4 and/or the network node 600 of FIG. 6), and the host (such as the host 416 of FIG. 4 and/or the host 700 of FIG. 7) discussed in the preceding paragraphs will now be described with reference to FIG. 9.

Like the host 700, embodiments of the host 902 include hardware, such as a communication interface, processing circuitry, and memory. The host 902 also includes software, which is stored in or is accessible by the host 902 and executable by the processing circuitry. The software includes a host application that may be operable to provide a service to a remote user, such as the UE 906 connecting via an OTT connection 950 extending between the UE 906 and the host 902. In providing the service to the remote user, a host application may provide user data which is transmitted using the OTT connection 950.

The network node 904 includes hardware enabling it to communicate with the host 902 and the UE 906 via a connection 960. The connection 960 may be direct or pass through a core network (like the core network 406 of FIG. 4) and/or one or more other intermediate networks, such as one or more public, private, or hosted networks. For example, an intermediate network may be a backbone network or the Internet.

The UE 906 includes hardware and software, which is stored in or accessible by the UE 906 and executable by the UE's processing circuitry. The software includes a client application, such as a web browser or operator-specific “app” that may be operable to provide a service to a human or non-human user via the UE 906 with the support of the host 902. In the host 902, an executing host application may communicate with the executing client application via the OTT connection 950 terminating at the UE 906 and the host 902. In providing the service to the user, the UE's client application may receive request data from the host's host application and provide user data in response to the request data. The OTT connection 950 may transfer both the request data and the user data. The UE's client application may interact with the user to generate the user data that it provides to the host application through the OTT connection 950.

The OTT connection 950 may extend via the connection 960 between the host 902 and the network node 904 and via a wireless connection 970 between the network node 904 and the UE 906 to provide the connection between the host 902 and the UE 906. The connection 960 and the wireless connection 970, over which the OTT connection 950 may be provided, have been drawn abstractly to illustrate the communication between the host 902 and the UE 906 via the network node 904, without explicit reference to any intermediary devices and the precise routing of messages via these devices.

As an example of transmitting data via the OTT connection 950, in step 908, the host 902 provides user data, which may be performed by executing a host application. In some embodiments, the user data is associated with a particular human user interacting with the UE 906. In other embodiments, the user data is associated with a UE 906 that shares data with the host 902 without explicit human interaction. In step 910, the host 902 initiates a transmission carrying the user data towards the UE 906. The host 902 may initiate the transmission responsive to a request transmitted by the UE 906. The request may be caused by human interaction with the UE 906 or by operation of the client application executing on the UE 906. The transmission may pass via the network node 904 in accordance with the teachings of the embodiments described throughout this disclosure. Accordingly, in step 912, the network node 904 transmits to the UE 906 the user data that was carried in the transmission that the host 902 initiated, in accordance with the teachings of the embodiments described throughout this disclosure. In step 914, the UE 906 receives the user data carried in the transmission, which may be performed by a client application executed on the UE 906 associated with the host application executed by the host 902.

In some examples, the UE 906 executes a client application which provides user data to the host 902. The user data may be provided in reaction or response to the data received from the host 902. Accordingly, in step 916, the UE 906 may provide user data, which may be performed by executing the client application. In providing the user data, the client application may further consider user input received from the user via an input/output interface of the UE 906. Regardless of the specific manner in which the user data was provided, the UE 906 initiates, in step 918, transmission of the user data towards the host 902 via the network node 904. In step 920, in accordance with the teachings of the embodiments described throughout this disclosure, the network node 904 receives user data from the UE 906 and initiates transmission of the received user data towards the host 902. In step 922, the host 902 receives the user data carried in the transmission initiated by the UE 906.

One or more of the various embodiments improve the performance of OTT services provided to the UE 906 using the OTT connection 950, in which the wireless connection 970 forms the last segment. More precisely, the teachings of these embodiments may improve power consumption, etc. and thereby provide benefits such as, extended battery lifetime.

In an example scenario, factory status information may be collected and analyzed by the host 902. As another example, the host 902 may process audio and video data which may have been retrieved from a UE for use in creating maps. As another example, the host 902 may collect and analyze real-time data to assist in controlling vehicle congestion (e.g., controlling traffic lights). As another example, the host 902 may store surveillance video uploaded by a UE. As another example, the host 902 may store or control access to media content such as video, audio, VR, or AR which it can broadcast, multicast, or unicast to UEs. As other examples, the host 902 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 950 between the host 902 and the UE 906 in response to variations in the measurement results. The measurement procedure and/or the network functionality for reconfiguring the OTT connection 950 may be implemented in software and hardware of the host 902 and/or the UE 906. In some embodiments, sensors (not shown) may be deployed in or in association with other devices through which the OTT connection 950 passes; the sensors may participate in the measurement procedure by supplying values of the monitored quantities exemplified above, or by supplying values of other physical quantities from which software may compute or estimate the monitored quantities. The reconfiguring of the OTT connection 950 may include message format, retransmission settings, preferred routing, etc.; the reconfiguring need not directly alter the operation of the network node 904. Such procedures and functionalities may be known and practiced in the art. In certain embodiments, measurements may involve proprietary UE signaling that facilitates measurements of throughput, propagation times, latency, and the like by the host 902. The measurements may be implemented in that software causes messages to be transmitted, in particular empty or ‘dummy’ messages, using the OTT connection 950 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

Some example embodiments of the present disclosure are as follows:

### Group A Embodiments

Embodiment 1: A method performed by a User Equipment, UE, the method comprising:
after or during performance of a random access procedure (e.g., a RACH procedure) in dual connectivity operation (e.g., MR-DC operation such as, e.g., a NR-DC operation, EN-DC operation, or NE-DC operation):
   upon performing a random access procedure toward a cell belonging to a secondary cell group, SCG, of the UE, logging (202) (e.g., in a random access report), information comprising a Global Cell Identity, CGI, and tracking area code, TAC, of a Primary Cell, PCell, of the UE.

Embodiment 2: The method of embodiment 1 wherein the UE logs the CGI and TAC of the PCell only if a global cell identity of a Primary Secondary Cell, PSCell, is not available at the UE or otherwise not known by the UE.

Embodiment 3: The method of embodiment 1 or 2 wherein the logged information further comprises one or more of the following:
a Physical Cell Identity, PCI, of the cell belonging to the SCG toward which the UE performed the RA procedure;
ARFCN of the cell belonging to the SCG toward which the UE performed the RA procedure;
an indication on whether the random access procedure is performed on an SCell belonging to SCG PCI of the secondary cell.

Embodiment 4: The method of any of embodiments 1 to 3 further comprising sending (204) a report comprising the logged information to a network node.

Embodiment 5: The method of any of embodiments 1 to 4 wherein the cell belong to the SCG toward which the random access procedure is performed is a Primary Secondary cell, PSCell.

Embodiment 6: The method of any of embodiments 1 to 4 wherein the cell belonging to the SCG toward which the random access procedure is performed is a Secondary Cell, SCell, belonging to the set of SCG cells.

Embodiment 7: A method performed by a User Equipment, UE, the method comprising: logging (202) (e.g., in a random access report), a Global Cell Identity, CGI, of a Primary Cell, PCell, of the UE in a random access log in response to performing a random access procedure toward a cell belonging to a secondary cell group, SCG, of the UE, when a PSCell identity is not available at the UE at the time of logging the random access report.

Embodiment 8: The method of embodiment 7 wherein the logged information further comprises a tracking area code, TAC, of the PCell of the UE.

Embodiment 9: The method of embodiment 7 or 8 wherein the logging is performed after or during performance of the random access procedure (e.g., a RACH procedure) toward the cell belong to SCG of the UE in dual connectivity operation (e.g., MR-DC operation such as, e.g., a NR-DC operation, EN-DC operation, or NE-DC operation).

Embodiment 10: The method of any of the previous embodiments, further comprising: providing user data; and forwarding the user data to a host via the transmission to the network node.

### Group B Embodiments

Embodiment 11: A method performed by a network node acting as owner of a cell that served a UE as a PCell, the method comprising:
receiving a random access report comprising a global cell identity of the PCell and a physical cell identity of a cell belonging to a SCG of the UE (e.g., a PSCell or an SCell belonging to the SCG);
upon receiving the random access report comprising the global cell identity of the PCell and the physical cell identity of the cell belonging to the SCG of the UE:
   determining whether the random access report should be forwarded to a RAN node owning/serving the PSCell or SCell for the UE (e.g., based on the global cell identity of the PCell and the physical cell identity of the cell belonging to the SCG of the UE);
   determining a global cell identity of a cell toward which a respective random access procedure was performed based on a neighbor relation table (e.g., by mapping the physical cell identity and frequency information (ARFCN) to a global cell identity of the cell toward which the random access procedure was performed); and
   forwarding the random access report to a RAN node that owns/serves the cell identified by the determined global cell identity.

Embodiment 12: The method of any of the previous embodiments, further comprising: obtaining user data; and forwarding the user data to a host or a user equipment.

### Group C Embodiments

Embodiment 13: A user equipment comprising: processing circuitry configured to perform any of the steps of any of the Group A embodiments; and power supply circuitry configured to supply power to the processing circuitry.

Embodiment 14: A network node comprising: processing circuitry configured to perform any of the steps of any of the Group B embodiments; and power supply circuitry configured to supply power to the processing circuitry.

Embodiment 15: A user equipment (UE) comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 16: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to receive the user data from the host.

Embodiment 17: The host of the previous embodiment, wherein the cellular network further includes a network node configured to communicate with the UE to transmit the user data to the UE from the host.

Embodiment 18: The host of the previous 2 embodiments, wherein: the processing circuitry of the host is configured to execute a host application, thereby providing the user data; and the host application is configured to interact with a client application executing on the UE, the client application being associated with the host application.

Embodiment 19: A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Embodiment 20: The method of the previous embodiment, further comprising: at the host, executing a host application associated with a client application executing on the UE to receive the user data from the UE.

Embodiment 21: The method of the previous embodiment, further comprising: at the host, transmitting input data to the client application executing on the UE, the input data being provided by executing the host application, wherein the user data is provided by the client application in response to the input data from the host application.

Embodiment 22: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.

Embodiment 23: The host of the previous embodiment, wherein the cellular network further includes a network node configured to communicate with the UE to transmit the user data from the UE to the host.

Embodiment 24: The host of the previous 2 embodiments, wherein: the processing circuitry of the host is configured to execute a host application, thereby providing the user data; and the host application is configured to interact with a client application executing on the UE, the client application being associated with the host application.

Embodiment 25: A method implemented by a host configured to operate in a communication system that further includes a network node and a user equipment (UE), the method comprising: at the host, receiving user data transmitted to the host via the network node by the UE, wherein the UE performs any of the steps of any of the Group A embodiments to transmit the user data to the host.

Embodiment 26: The method of the previous embodiment, further comprising: at the host, executing a host application associated with a client application executing on the UE to receive the user data from the UE.

Embodiment 27: The method of the previous embodiment, further comprising: at the host, transmitting input data to the client application executing on the UE, the input data being provided by executing the host application, wherein the user data is provided by the client application in response to the input data from the host application.

Embodiment 28: A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

Embodiment 29: The host of the previous embodiment, wherein: the processing circuitry of the host is configured to execute a host application that provides the user data; and the UE comprises processing circuitry configured to execute a client application associated with the host application to receive the transmission of user data from the host.

Embodiment 30: A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B embodiments to transmit the user data from the host to the UE.

Embodiment 31: The method of the previous embodiment, further comprising, at the network node, transmitting the user data provided by the host for the UE.

Embodiment 32: The method of any of the previous 2 embodiments, wherein the user data is provided at the host by executing a host application that interacts with a client application executing on the UE, the client application being associated with the host application.

Embodiment 33: A communication system configured to provide an over-the-top service, the communication system comprising a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

Embodiment 34: The communication system of the previous embodiment, further comprising: the network node; and/or the user equipment.

Embodiment 35: A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

Embodiment 36: The host of the previous 2 embodiments, wherein: the processing circuitry of the host is configured to execute a host application, thereby providing the user data; and the host application is configured to interact with a client application executing on the UE, the client application being associated with the host application.

Embodiment 37: The host of the any of the previous 2 embodiments, wherein the initiating receipt of the user data comprises requesting the user data.

Embodiment 38: A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B embodiments to receive the user data from the UE for the host.

Embodiment 39: The method of the previous embodiment, further comprising at the network node, transmitting the received user data to the host.

Those skilled in the art will recognize improvements and modifications to the embodiments of the present disclosure. All such improvements and modifications are considered within the scope of the concepts disclosed herein.

1. A method performed by a User Equipment (UE) which is served by a Primary Cell (PCell) the method comprising:
performing a random access procedure toward a cell associated to a secondary cell group (SCG) of the UE;
logging information for a random access (RA) report associated to the random access procedure, wherein:
a global cell identity of a Primary Secondary Cell (PSCell) is not available at the UE; and
the information logged for the RA report comprises a Global Cell Identity (CGI) of the PCell of the UE, as a result of the global cell identity of the PSCell not being available at the UE; and
sending the RA report comprising the logged information to a network node.

2. The method of claim 1, wherein logging the information comprising the CGI of the PCell of the UE for the RA report comprises logging the information comprising the CGI of the PCell of the UE for the RA report after or during performing the random access procedure in dual connectivity operation.

3. The method of claim 1, wherein the UE logs the CGI of the PCell for the RA report only if a global cell identity of the PSCell is not available at the UE.

4. The method of claim 1, wherein the cell associated to the SCG of the UE is a Secondary Cell (SCell) of the SCG.

5. The method of claim 1, wherein the cell associated to the SCG of the UE is the PSCell.

6. The method of claim 1, wherein the logged information for the RA report further comprises a Tracking Area Code (TAC) of the PCell of the UE.

7. The method of claim 1, wherein the logged information for the RA report further comprises one or more of the following:
a Physical Cell Identity (PCI) of the cell associated to the SCG toward which the UE performed the random access procedure;
an Absolute Radio Frequency Channel Number (ARFCN) of the cell associated to the SCG toward which the UE performed the random access procedure;
an indication on whether the random access procedure is performed on an SCell belonging to SCG associated to the cell toward which the UE performed the random access procedure.

8. The method of claim 1, wherein the cell associated to the SCG of the UE is a cell of a New Radio (NR) or Long Term Evolution (LTE) network.

9. The method of claim 1, wherein sending the RA report comprising the logged information to the network node comprises sending the RA report comprising the logged information to the network node upon network request.

10. A User Equipment (UE), which is served by a Primary Cell (PCell), the UE comprising:
a communication interface comprising a transmitter and a receiver; and
processing circuitry associated with the communication interface, the processing circuitry configured to cause the UE to:
perform a random access procedure toward a cell associated to a secondary cell group (SCG) of the UE;
log information for a random access (RA) report associated to the random access procedure, wherein:
a global cell identity of a Primary Secondary Cell (PSCell) is not available at the UE; and
the information logged for the RA report comprises a Global Cell Identity (CGI), of the PCell of the UE, as a result of the global cell identity of the PSCell not being available at the UE; and
send the RA report comprising the logged information to a network node.

11. The UE of claim 10, wherein the processing circuitry is further configured to cause the UE to log the information comprising the CGI of the PCell of the UE for the RA report after or during performing the random access procedure in dual connectivity operation.

12. The UE of claim 10, wherein the processing circuitry is further configured to cause the UE to logs the CGI of the PCell for the RA report only if a global cell identity of the PSCell is not available at the UE.

13. The UE of claim 10, wherein the cell associated to the SCG of the UE is a Secondary Cell (SCell) of the SCG.

14. The UE of claim 10, wherein the cell associated to the SCG of the UE is a Primary Secondary Cell (PSCell).

15. The UE of claim 10, wherein the UE is further adapted to send the RA report comprising the logged information to the network node upon network request.

16. A non-transitory computer-readable medium comprising instructions executable by processing circuitry of a User Equipment (UE), which is served by a Primary Cell (PCell), whereby the UE is caused to:
perform a random access procedure toward a cell associated to a secondary cell group (SCG) of the UE;
log information for a random access (RA) report associated to the random access procedure, wherein:
a global cell identity of a Primary Secondary Cell (PSCell) is not available at the UE; and
the information logged for the RA report comprises a Global Cell Identity (CGI) of the PCell of the UE, as a result of the global cell identity of the PSCell not being available at the UE; and
send the RA report comprising the logged information to a network node.

17. (canceled)

18. A method performed by a network node acting as owner of a cell that serves a User Equipment (UE) as a Primary Cell (PCell) of the UE, the method comprising:
receiving a random access report comprising a global cell identity of the PCell and a physical cell identity of a cell associated to a Secondary Cell Group (SCG) of the UE toward which the UE performed a random access procedure;
upon receiving the random access report comprising the global cell identity of the PCell and the physical cell identity of the cell associated to the SCG of the UE:
determining that the random access report should be forwarded to a Radio Access Network (RAN) node serving the cell associated to the SCG of the UE toward which the UE performed the random access procedure;
determining a global cell identity of the cell toward which the UE performed the random access procedure based on a neighbor relation table; and
forwarding the random access report to a RAN node that serves the cell identified by the determined global cell identity.

19. The method of claim 18, wherein the cell associated to the SCG of the UE toward which the UE performed the random access procedure is a Secondary Cell (SCell) of the SCG.

20. The method of claim 18, wherein the cell associated to the SCG of the UE toward which the UE performed the random access procedure is a Primary Secondary Cell (PSCell).

21. The method of claim 18, wherein determining the global cell identity of the cell toward which the UE performed the random access procedure comprises determining the global cell identity of the cell toward which the UE performed the random access procedure by mapping the physical cell identity and frequency information of the cell to a global cell identity of the cell toward which the random access procedure was performed.

22. The method of claim 18, wherein the random access report further comprises a Tracking Area Code (TAC) of the PCell of the UE.

23. The method of claim 18, wherein the random access report further comprises one or more of the following:
an Absolute Radio Frequency Channel Number (ARFCN) of the cell associated to the SCG toward which the UE performed the random access procedure;
an indication on whether the random access procedure is performed on an SCell belonging to SCG associated to the cell toward which the UE performed the random access procedure.

24. The method of claim 18, wherein the network node is a network node for a New Radio (NR) or Long Term Evolution (LTE) network.

25. A network node for acting as owner of a cell that serves a User Equipment (UE) as a Primary Cell (PCell), the network node adapted to:
receive a random access report comprising a global cell identity of the PCell and a physical cell identity of a cell associated to a Secondary Cell Group (SCG) of the UE toward which the UE performed a random access procedure;
upon receiving the random access report comprising the global cell identity of the PCell and the physical cell identity of the cell associated to the SCG of the UE:
determine that the random access report should be forwarded to a Radio Access Network (RAN) node serving the cell associated to the SCG of the UE toward which the UE performed the random access procedure;
determine a global cell identity of the cell toward which the UE performed the random access procedure based on a neighbor relation table; and
forward the random access report to a RAN node that serves the cell identified by the determined global cell identity.

26. (canceled)

27. A non-transitory computer-readable medium comprising instructions executable by processing circuitry of a network node acting as an owner of a cell that serves a User Equipment (UE) as a Primary Cell (PCell) of the UE whereby the network node is caused to:
receive a random access report comprising a global cell identity of the PCell and a physical cell identity of a cell associated to a Secondary Cell Group (SCG) of the UE toward which the UE performed a random access procedure;
upon receiving the random access report comprising the global cell identity of the PCell and the physical cell identity of the cell associated to the SCG of the UE;
determine that the random access report should be forwarded to a Radio Access Network (RAN) node serving the cell associated to the SCG of the UE toward which the UE performed the random access procedure;
determine a global cell identity of the cell toward which the UE performed the random access procedure based on a neighbor relation table; and
forward the random access report to a RAN node that serves the cell identified by the determined global cell identity.

28. (canceled)
